(19) United States
(12) Patent Application Publication
(10) Pub. No.: US 2011/0203375 A1
(43) Pub. Date: Aug. 25, 2011

(54) METHOD AND APPARATUS FOR ULTRASONIC INSPECTION

(76) Inventors: Peter Farthing, Devon (GB); Helge Nareid, Aberdeen (GB)

(21) Appl. No.: 13/063,618

(22) PCT Filed: Sep. 14, 2009
(86) PCT No.: PCT/GB2009/051185

§ 371 Date: Apr. 14, 2011

(30) Foreign Application Priority Data
Sep. 13, 2008 (GB) 0816804.9

(51) Int. Cl. G01N 29/04

(52) U.S. Cl. 73/628

(57) ABSTRACT

An inspection device in the form of an acoustic transducer with a number of transducer elements that are arranged in a circumferential array around substantially the whole circumference of the device, to transmit and receive acoustic signals around substantially the whole circumference of the device, typically at substantially the same time, allowing assessment of the inspected object from different perspectives without requiring moving parts on the inspection device. In some embodiments, the transducer elements are circumferentially offset to improve the resolution, and can be axially stacked along the device. Circumferential arrangement of the transducer elements in the device allows the device to transmit and receive signals around substantially its whole circumference, and thereby allows it to inspect whole pipe planar sections in real time, and without requiring rotation of the transducers, thereby avoiding moving parts. This also permits the device to measure and compare the return time and/or distance from the device to different points on a tubular being inspected, at the same axial location along the tubular, and this allows a qualitative or optionally a quantitative measurement of eccentricity.

The present invention relates to an inspection device, particularly useful for inspecting pipes.

It is known to inspect pipework by means of acoustic inspection devices which pass through the bore of the pipe and radially transmit acoustic signals from the device to the pipe wall, and determine the condition of the pipe wall (e.g. depth) by means of the signals returned from the wall and gathered by a receiver on the device.

The present invention provides an inspection device comprising:
an acoustic transducer comprising a plurality of transducer elements, the plurality of transducer elements incorporating
   a transmitter mechanism adapted to transmit acoustic signals from the device toward an inspected object to generate returned signals from the inspected object in response to the transmitted signals, and
   a receiver mechanism for receiving acoustic signals returned from the inspected object,

the plurality of transducer elements being arranged in a circumferential array around substantially the whole circumference of the device.

In some embodiments of the invention, the circumferential array is adapted to transmit and receive acoustic signals around substantially the whole circumference of the device, typically at substantially the same time, allowing assessment of the inspected object from different perspectives without requiring moving parts on the inspection device. In some embodiments, simultaneous transmission and reception on a circumferential basis is not needed, and the device can be used to transmit and receive signals on only a portion of the circumferential array, for example, at diametrically opposite positions on the array, at substantially the same or a different time. This allows the assessment of desired specific perspectives of the inspected object without moving the inspection device.

In a typical embodiment, the device has the transducer elements arranged in a staggered array, each transducer element being staggered with respect to at least one other transducer element in the array so that each element can be circumferentially offset with respect to at least one other transducer element within the array. This circumferential offsetting typically improves the resolution of the device.

In certain embodiments of the device, the array can be circular in cross section, but the transducer need not be circular, and the circumference of the array can have a square or some other cross-sectional shape.

The device can have an axis. The transducer elements can be arranged in an axially stacked array, with a first row of elements arranged side by side, arranged to transmit acoustic signals radially outward from the device, toward the item, and a second row of elements axially spaced from the first row of elements, wherein each element in the second row is circumferentially offset, and overlaps at least one and optionally two elements in the first row. There can be two, three, or more rows, axially stacked on top of one another in adjacent planes of the device. In some embodiments, the circumferential offset can be achieved by radially layering the transducer elements within the same plane. However, axial stacking of rows has some advantages over radial layering in some embodiments.

Circumferential arrangement of the transducer elements in the device allows the device to transmit and receive signals around substantially its whole circumference, and thereby allows it to inspect whole pipe planar sections in real time, and without requiring rotation of the transducers, thereby avoiding moving parts. This also permits the device to measure and compare the return time and/or distance from the device to different points on a tubular being inspected, at the same axial location along the tubular, and this allows a qualitative or optionally a quantitative measurement of eccentricity, which frequently occurs in oilfield tubulars, where the walls have a defined and constant thickness, but where the tubular is not perfectly cylindrical. The arrangement also allows measurement of concentricity of concentric strings, which allows evaluation of cement job quality in a non-invasive manner.

Typically the acoustic transducer transmits (and optionally receives) at a particular frequency, e.g. between 100 kHz-5 MHz. The frequency of the transmitted signal can be selected in accordance with the desired range of the device. Lower frequencies can yield longer ranges of reliable inspection. Optionally the device can transmit more than one acoustic frequency. Typically a single acoustic transducer element is adapted to transmit and receive at a single preset frequency, and the device can optionally have a number of different transducer elements adapted to transmit and receive at different frequencies. Optionally a row of transducer elements arranged in a single radial plane will all be adapted to transmit and receive at a single frequency, but the separate transducer elements that operate at the same frequency can be axially or radially spaced from one another if desired, although typically the separate transducer elements operating at the same frequency permit circumferential coverage of the device. Axially adjacent rows or layers can optionally be set to transmit and receive at the same frequency, so that a stacked array of transducer elements operates at a single frequency that transmits and receives with 360 degree coverage around the circumference of the device.

A stack of transducer elements operating at one frequency can be stacked axially adjacent to another stack operating at a different frequency. For example, the transducer can comprise a first stack of transducer elements operating at 200 kHz wherein the first stack comprises 5-20 rows of elements (e.g. 16 rows) that are each circumferentially offset with respect to one another so as to cover the whole circumference of the stack. The number of rows in the first stack can be variable, e.g. 3, 5, 10, 16 rows etc, dependent on the degree of circumferential offsetting between the elements in the rows, and the desired range of the device. The more rows present in a stack, the better the resolution of the signals and the more sensitive the device. Therefore, some basic devices with a low resolution and a short range can be provided by just a single row, or only two rows of elements that can optionally be circumferentially offset, but more sensitive embodiments will typically have 15-25 rows per stack, and these will typically be circumferentially offset. Optionally there are around 15-25 (e.g. 16) elements per row, but this is again dependent on the size of the elements and on the desired resolution, and in some embodiments, on the range of the device.

The transducer can have a second stack of the same or a different number of rows of elements operating at the same or a different frequency, for example 500 kHz, and scanning at the same or a different range from the first stack. The second stack can be axially spaced from the first stack, or adjacent to it. A third and fourth stack operating at other frequencies again can also be included, dependent on the range of cross-sectional areas to be investigated by the device. In some embodiments the device can transmit and/or receive more than one type of acoustic signal. For example, in some cases, each transducer can emit different frequencies of acoustic signal, optionally at the same time.

Transducer elements operating at the same frequency can be arranged together on the device, but this is not essential. In certain embodiments, the transducer elements operating at the same frequency are grouped in rows and stacks. In alternative embodiments, they could be grouped in axial strings or in helices, or not grouped together at all.

Typically a single transducer contains both a receiver mechanism and a transmitter mechanism within the same transducer element. In certain embodiments it would be possible to provide transmitter mechanisms and receiver mechanisms within separate transducers within the array.

Some transducer elements can typically comprise a coil and a core. Passing electrical current through the coil can energise the core and cause it to transmit the acoustic signal. Reception of an acoustic signal by the element can energise the coil, which can result in a detectable electrical impulse in the coil and a detectable signal at a controller. In some embodiments the transducer element can include a piezoelectric material, adapted to deform when an electrical voltage is applied to it, or to generate an electrical voltage when mechanical force is applied to it. The transducer element can be tuned to a particular resonant frequency, and when a signal at or close to the resonant frequency is applied to the transducer element, an acoustic pressure wave is typically generated by the transducer. In a similar manner, an electrical signal can be generated by the transducer element when it encounters an acoustical pressure wave at or near the resonant frequency of the transducer element. Typically the elements deform optimally when the wave is incident on the transducer element. Piezoelectric transducer elements can be used as transmitters, or receivers or both.

According to a second aspect, the present invention also provides a method for inspecting an object, the method comprising the steps of:
generating acoustic signals from an acoustic transducer within range of the object, so that acoustic signals from the transducer are returned from the object and are received at the transducer;
wherein the acoustic transducer has a plurality of transducer elements being arranged in a circumferential array around substantially the whole circumference of the transducer.

Typically the array is adapted to transmit and receive acoustic signals around substantially the whole circumference of the array.

According to a third aspect, the present invention also provides an inspection device comprising an acoustic transducer, the acoustic transducer having
a plurality of transducer elements arranged in a first array, the first array having a transmitter mechanism adapted to transmit acoustic signals from the device toward an inspected object to generate returned signals from the inspected object in response to the transmitted signals, and a receiver mechanism for receiving acoustic signals returned from the inspected object; and wherein the first array is adapted to transmit and receive acoustic signals at a first frequency; and
a plurality of transducer elements arranged in a second array, the second array having a transmitter mechanism adapted to transmit acoustic signals from the device toward an inspected object to generate returned signals from the inspected object in response to the transmitted signals, and a receiver mechanism for receiving acoustic signals returned from the inspected object; and wherein the second array is adapted to transmit and receive acoustic signals at a second frequency.

The acoustic transducer elements of the third aspect of the invention can be arranged in stacked and/or circumferentially offset arrays as indicated in the first and second aspects.

According to a fourth aspect, the present invention also provides a method of inspecting an object, the method comprising the steps of:

generating acoustic signals from a transducer within range of the object, so that acoustic signals from the transducer are returned from the object and are received at the transducer, and wherein the transducer comprises a first array of transducer elements and a second array of transducer elements;
transmitting acoustic signals at a first frequency from the first array of transducers; and
transmitting acoustic signals at a second frequency from the second array of transducers.

Features described with reference to the first aspect of the invention can typically be combined with the second to fourth aspects of the invention.

Embodiments of the present invention will now be described, by way of example, with reference to the accompanying drawings, in which:

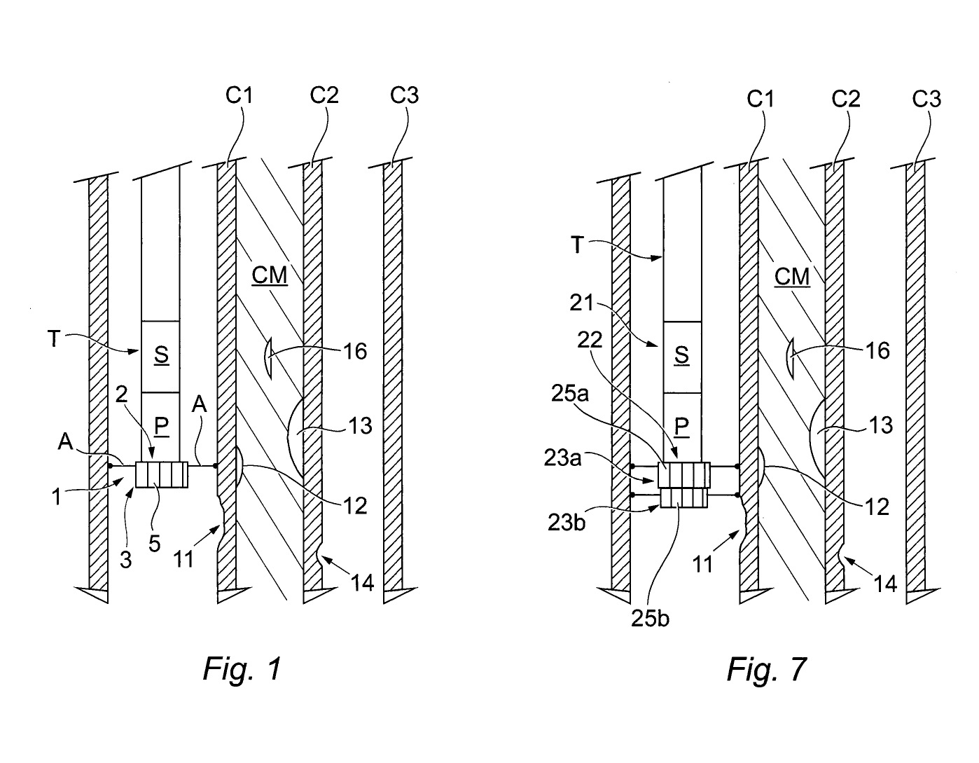

FIG. 1 is a schematic side view of an inspection device according to the invention;

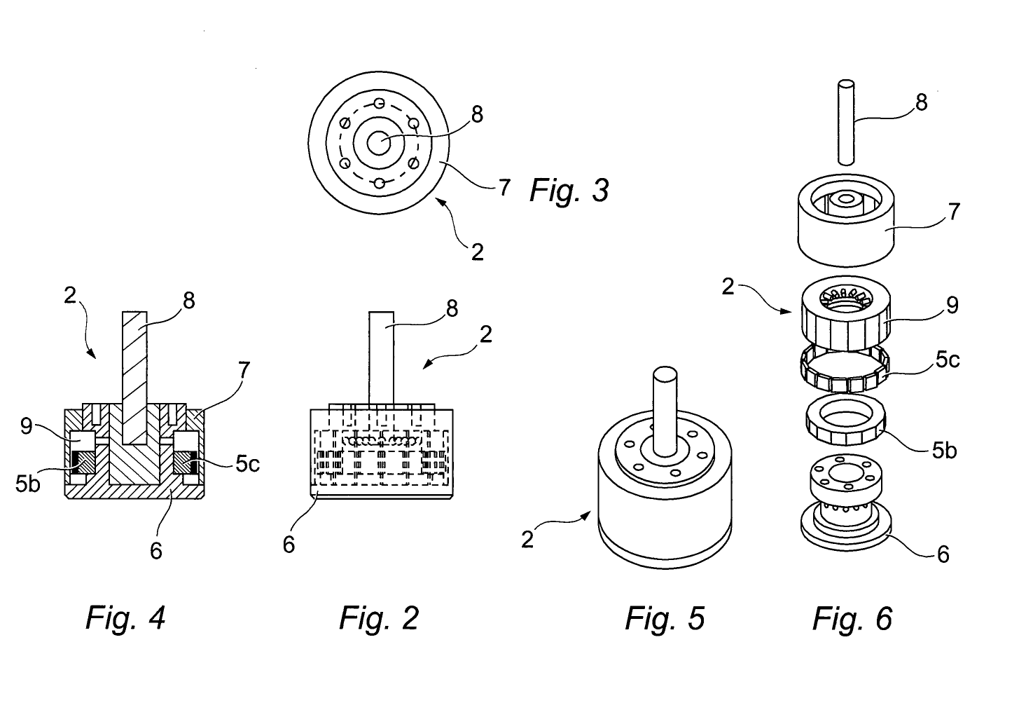

FIG. 2 is a schematic side view of a transducer of the FIG. 1 inspection device;

FIG. 3 is a plan view of the FIG. 2 transducer.

FIG. 4 is a sectional view through the line B-B of FIG. 2;

FIG. 5 is a perspective view of the FIG. 2 transducer;

FIG. 6 is an exploded view of the components of FIG. 5;

FIG. 7 is a side view of a second device;

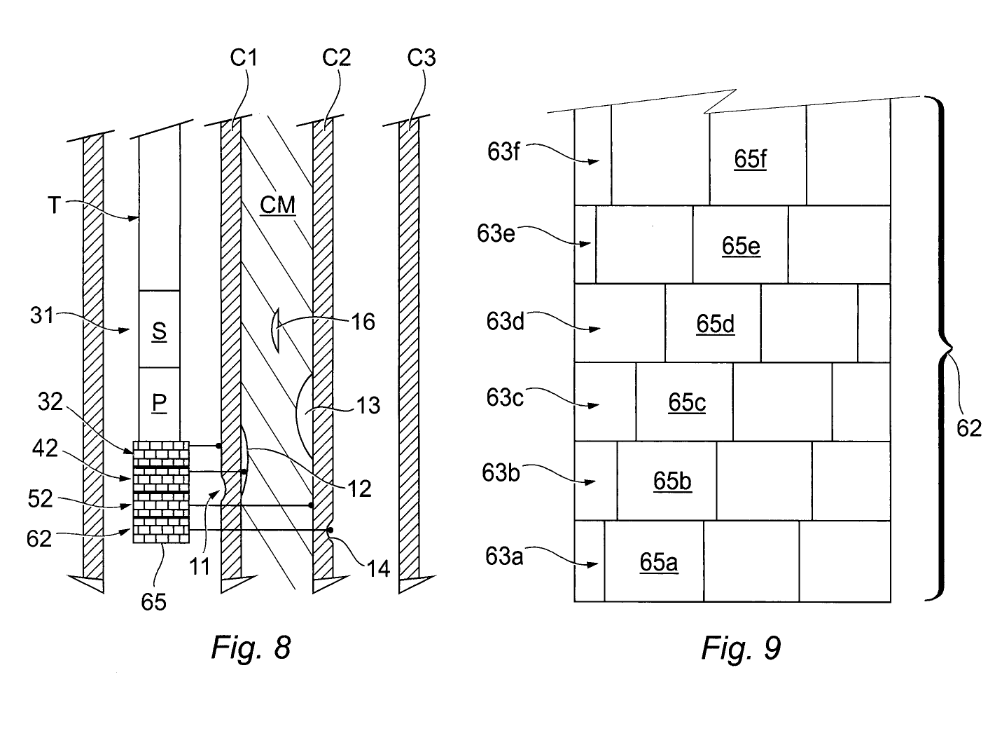

FIG. 8 is a side view of a third device;

FIG. 9 is an enlarged side view of a transducer of the FIG. 7 device;

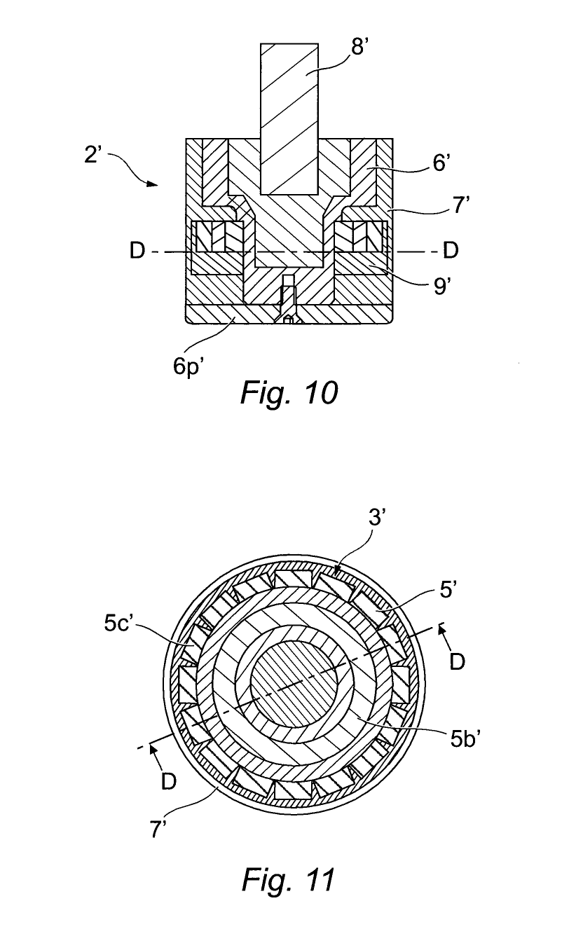

FIG. 10 is a sectional view similar to FIG. 4 through a similar embodiment; and

FIG. 11 is sectional view through the line D-D of FIG. 10.

Referring now to the drawings, FIG. 1 shows a first inspection device 1 in a borehole. The borehole is lined with three concentric strings of casing C1, C2, C3. The casing strings, and optionally the cement CM between the casing strings, are being inspected by the device 1. The device 1 is deployed on the end of a tubing string T into the bore of the innermost string C1. The device does not need to be deployed on the end of a string, and could be incorporated into a longer string with subs above and below it. Also, the device 1 could be deployed on wireline or the like, without using the tubing T. The outer strings C2 and C3 surround the innermost string, and all the strings C1, C2, C3 are located radially outward from the device 1. The casing strings and the cement have a number of discontinuities at 11, 12, 13, and 14.

The device 1 has a single transducer 2, comprising a row 3 of transducer elements 5. In the example shown in FIGS. 1-6, there is a single row 3 of transducer elements 5, but additional rows of elements could be stacked in different axial planes on top of the row 3, or could be layered in the same plane behind or in front of the row 3, so as to be concentric with row 3. The transducer elements in the row 3 are identical. Each of the elements transmits and receives acoustic signals in a radial direction, outwardly from the row around substantially the entire circumference of the device 1.

Acoustic signals A transmitted from the transducer 2 travel from the transducer elements 5 to the inside wall of the inner casing string C1, and when they hit the inner surface of the casing string C1 a return signal is generated back toward the transducer 2, which is picked up by the transducer elements 5, and converted into electronic signals by an onboard processor P, and the data stored in on board memory S. Optionally the processor P and memory S can be remote from the device 1. As shown in FIGS. 2-6, the transducer 2 can optionally have a protective housing 6, a plastic covering 7 to prevent abrasion, and a cable 8 for reporting data. The transducer elements 5 can comprise active composite elements 5c mounted on a backing material 5b, which holds the active elements 5b in the correct position, and which dampens acoustic waves propagating back into the processor housing, in order to reduce multiple reflections and crosstalk between the transducer elements 5. In addition, a matching layer 9 is used to match the acoustic properties of the piezoelectric material and the surrounding liquid so as to minimise losses and reflections at interfaces.

A similar transducer 2′ is shown in FIGS. 10 and 11. The transducer 2′, comprising a row 3′ of transducer elements 5′. In the example shown in FIGS. 10 and 11, there is a single row 3′ of transducer elements 5′, but additional rows of elements could be stacked in different axial planes on top of the row 3′, or could be layered in the same plane behind or in front of the row 3′, so as to be concentric with row 3′. The transducer elements in the row 3′ are identical. Each of the elements transmits and receives acoustic signals in a radial direction, outwardly from the row around substantially the entire circumference of the device. The transducer elements are typically arranged in the same radial plane as a damping and backing layer, which are typically set radially behind the transducers.

Acoustic signals are transmitted by, return to, and are processed by the transducer 2′ in the same way as transducer 2. As shown in FIGS. 10 and 11, the transducer 2′ can optionally have a protective housing 6′ with a protective end plate 6p′, a plastic covering 7′ to prevent abrasion, and a cable 8′ for reporting data. The transducer elements 5′ can comprise active composite elements 5c′ mounted on a backing material 5b′, which holds the active elements 5b′ in the correct position, and which dampens acoustic waves propagating back into the processor housing, in order to reduce multiple reflections and crosstalk between the transducer elements 5′. Multiple layers of backing material can be provided. In addition, a matching layer 9′ is used to match the acoustic properties of the piezoelectric material and the surrounding liquid so as to minimise losses and reflections at interfaces.

The embodiment shown in FIGS. 1-6 and that shown in FIGS. 10-11 can adequately scan the inner surface of the inner string C1, and will detect pitting at 11, or differences in the calculated distances or measured time returns between the device 1 and the walls of C1 in the same axial plane, which would tend to indicate oval distortion of the casing string C1. Return signal times can simply be measured in simple embodiments, and measured time discrepancies can be interpreted as discontinuities in the casing wall, for example. In some embodiments with quantitative assessment capabilities, the measured return times can be converted to calculated distance, based on a comparison of the time for a transmitted signal to travel from the transducer to the inside wall and travel back again as a return signal, and deriving from this time measurement the corresponding distance using standard values of speed of sound in e.g. air, water, and most metals. Speed of sound values can be readily found in published literature, for example, in “Handbook of Chemistry and Physics” Chemical Rubber Company, Cleveland Ohio, table E-28; J. David N. Cheeke: “Fundamentals and Applications of Ultrasonic Waves”, CRC press 2002, ISBN 0-8493-0130-0, appendix B; Kaye & Laby: “Tables of Physical & Chemical Constants”, National Physical Laboratory (NPL) , http://kayelaby.npl.co.uk/, section 2.4.1—“The speed and attenuation of sound.” For example, given that speed=distance/time and knowing that the speed of sound in water is 1400 m/s and knowing the time taken for the signal to bounce back from the casing to the transducer through the water, it is possible to calculate the distance from the transducer to the casing. The materials of the casing are generally known beforehand, and the speed of sound in the casing (e.g. speed of sound in steel is 5000 m/s) will also be information known or readily available to the skilled person. It is also possible to construct qualitative and not necessarily quantitative embodiments which detect discontinuities in the distances, without necessarily calculating the distances themselves.

In some cases, the speed of sound in the medium immediately surrounding the device can optionally be measured by including a speed-of-sound test cell in the device. A speed of sound test can typically be implemented by measuring the traverse time of an ultrasonic pulse over a known distance. A simple test cell located on the device can optionally comprise a simple annular sleeve arranged around a reference transducer, and defining a reference cavity of fixed and known dimensions, which occupies a part of the annulus between the device and the inner string in which it is disposed, and which has an opening to allow the test cavity to fill with the fluid medium surrounding the device, e.g. with the water or oil surrounding the device in the bore of the casing. Thus the distance between the reference transducer and the reference cavity is known, and the frequency and wavelength of the reference transducer is also known, and so upon measurement of the time taken for the return signal from the reference sleeve to reach the reference transducer can be used to confirm the speed of sound in the fluid medium surrounding the device. It is possible to refine the measurement by analysing the phase response of the measurement for a range of closely spaced frequencies, in order to more accurately determine the number of wavelengths contained within the measurement range at a given frequency.

The materials in the annuli between casings are either known (e.g. water or concrete), or in the case of a leak can be assumed to be equivalent to the fluid in the inner casing string. The acoustic properties of metals do not change significantly over the pressure and temperatures within the instrument's range.

The data can be logged as the device is run into the hole on the tubing T, and the discontinuities such as pitting and oval distortions are optionally logged with respect to depth, either by the onboard circuitry or by remote processors and/or data storage devices, and optionally mapped.

Referring now to FIG. 7 a second embodiment of an inspection device 21 is shown in the same borehole with the three concentric strings of casing C1, C2, and C3. Features in common with the first device 1 are given the same reference numbers, increased by 20.

The second device 21 has a single transducer 22 with two rows 23a and 23b of transducer elements 25a and 25b stacked on top of one another. However, this is schematic, and while two rows would suffice, more rows per transducer could be added. The transducer 22 therefore has an axially stacked array of transducer elements 25. The transducer elements in each of the separate rows are identical, but the elements 25a in the first row 23a are offset circumferentially from the elements 25b in the second row 23b, so that the elements in each row overlap with the elements in at least one of the other rows. In this example, the elements 25a are circumferentially offset by 3 degrees from the elements 25b.

Each of the elements transmits and receives acoustic signals in a radial direction, outwardly from the row, around the circumference of the device 21. Since each element in each row is offset with respect to at least one other element in the array, the radial direction of transmission and reception of each individual element 25 is also offset. As a result of the circumferential coverage of the transducer 22 by the elements 25, the transducer 22 transmits and receives acoustic signals around substantially the entire circumference of the transducer 22. The resolution of the transducer 22 can be improved by offsetting, and by adding more rows of elements 25, so that the offset between adjacent rows is reduced. The elements 25 and the transducer 22 can have a similar structure and function as the transducer 2 and the elements 5 in the first embodiment.

The second embodiment shown in FIG. 7 can scan the inner surface of the inner string C1 at a higher resolution than the first embodiment, because the offsetting of the different rows 23a, 23b of transducer elements 25a, 25b scans more of the inner surface of the casing C1, and will detect very small discontinuities of the casing string C1 that would not be detected by the simpler first embodiment. The data can be logged as the device is run into the hole on the tubing T, and the discontinuities such as pitting and oval distortions are optionally logged with respect to depth, either by the onboard circuitry or by remote processors and/or data storage devices, and optionally mapped.

Referring now to FIGS. 8 and 9 a third embodiment of an inspection device 31 is shown in the same borehole with the three concentric strings of casing C1, C2, and C3.

The third device 31 has four separate transducers 32, 42, 52 and 62, each stacked axially on top of one another. Each transducer 32, 42, 52 and 62 has multiple rows of transducer elements stacked on top of one another. For example, the transducer 62 at the bottom of the stack has sixteen rows 63a-p (note for clarity in the drawings only three of these rows are shown in FIG. 8 and only six rows 63a-f are shown in the expanded FIG. 9) but this is schematic, and more rows of elements per transducer could be added. The transducer 62 therefore has a stacked array of transducer elements 65. The transducer elements 65 in each of the separate rows 63 are identical, but the elements 65a in the first row 63a are offset circumferentially from the elements 65b in the second row 63b, so that in each transducer 32, 42, 52, 62, the elements in each row overlap with the elements in at least one of the other rows. In this example, the elements 65a are circumferentially offset by 2 degrees from the elements 65b etc.

Each of the elements 65 transmits and receives acoustic signals in a radial direction, outwardly from the row, around the circumference of the device 31. Since each element 65 in each row 63 is offset with respect to at least one other element in the array, the radial direction of transmission and reception of each individual element 65 in the transducer 62 is also offset. The circumferential coverage of the transducer 62 by the elements 65 permits the transducer 62 to transmit and receive acoustic signals around substantially the entire circumference of the transducer 62. The resolution of the transducer 62 can be improved by offsetting, and by adding more rows of elements 65, so that the angle of offset between adjacent rows is reduced. The elements 65 and the transducer 62 can have a similar structure and function as the transducer 2 and the elements 5 in the first embodiment, with additional rows of elements provided on each transducer. Each of the other transducers 32, 42 and 52 of the third device 31 has a similar structure and function to the fourth transducer 65.

The third embodiment shown in FIGS. 8 and 9 can scan the inner surface of the inner string C1 at a higher resolution than the second embodiment 21, because of the comparatively increased offsetting of the different rows 63a, 63b of transducer elements 65a, and 65b. The data can be logged as the device is run into the hole on the tubing T, and the discontinuities such as pitting and oval distortions are optionally logged with respect to depth, either by the onboard circuitry or by remote processors and/or data storage devices, and optionally mapped.

The elements in the different transducers typically transmit and receive at different frequencies. For example, the first transducer 32 operates at 2 MHz, the second 42 at 1 MHz, the third 52 at 0.5 MHz (500 kHz) and the fourth 62 at 0.2 MHz (200 kHz). The frequencies are exemplary and other frequencies can be used without departing from the scope of the invention. In each case, the acoustic signal is transmitted around substantially the whole circumference of the transducers 32, 42, 52 and 62 outwardly toward the casing strings C1, C2 and C3. Any discontinuities in the medium through which the signals pass causes a reflection of the signal back to the device 31 which is picked up by the relevant transducer operating at the required frequency. The time taken between the transmitted signal leaving the device, and the return signal reaching the device is measured by the processor P, which can be local to the device 1 or can be located elsewhere e.g. topsides on a rig, and this measurement is converted into distance as a function of the speed of sound in the particular medium concerned, which is generally known beforehand.

The different frequencies of the four transducers 32, 42, 52, 62 give the respective signals transmitted by the transducers different ranges. The lower the frequency the longer the range of the signal. Since some loss of signal can occur on longer ranges, the lower frequency transducers 52 and 62 can optionally have more rows of transducer elements than the higher frequency transducers 32 and 42. The different transducers 32, 42, 52, 62 are therefore focused to inspect particular areas of the wellbore. For example, the high frequency transducers 32 and 42 are arranged to focus respectively on the inner and outer surfaces of the inner string C1. The lower frequency transducers 52 and 62 are arranged to focus respectively on the inner and outer surfaces of the second casing string C2. Thus the device 31 can pick up discontinuities in the casing surface inside the wellbore or in the annulus, in the inner and the outer string(s), in real time, without moving parts, and can give data allowing the assessment of ovality and concentricity in the outer strings, all within a single trip into the wellbore. This data can be correlated with the measured depth of the tubing string T, and a map of the casing strings can thereby be constructed without invasion of the annulus between the casing strings C1, C2. Clearly it will be recognised by a skilled man that although not shown in the drawings for reasons of clarity, additional transducers can easily be added to focus on the inner and outer skin of the other casing strings C3 etc. A non-invasive survey in the bore of the well using the device 31 can therefore pick up the casing discontinuities at 11 in the inner string, and at 14 on the outer surface of the second string C2. The device will also pick up discontinuities in the cement in the annulus between the casing strings C1 and C2 at 12 and 13. Additional transducers of a similar design but operating at a different frequency can optionally be added to scan the areas between the casing strings to detect e.g. the cement bubble at 16, in between the casing string surfaces.

Modifications and improvements can be incorporated without departing from the scope of the invention.

1. An inspection device comprising a body for passing through a bore of a fluid bearing pipe for inspection of the pipe, the inspection device comprising an acoustic transducer comprising a plurality of transducer elements mounted on the body such that the plurality of transducer elements are radially spaced from a wall of the pipe, the plurality of transducer elements comprising:
a transmitter mechanism that transmits acoustic signals radially outwardly from the device through a fluid medium between the inspection device and the wall of the pipe, towards an inspected object to generate returned signals from the inspected object in response to the transmitted acoustic signals;
a receiver mechanism for receiving acoustic signals returned from the inspected object, the plurality of transducer elements being arranged in a circumferential array around substantially the whole circumference of the device, the circumferential array for transmitting and receiving acoustic signals around substantially the whole circumference of the device, enabling calculation of the distance between the transducers and the pipe based on the returned signals received at the array; and
wherein the acoustic transducer is configured to transmit signals at more than one acoustic frequency.

2. (canceled)

3. A device as claimed in claim 1, wherein the circumferential array transmits and receives acoustic signals at different positions on the circumference of the device at substantially the same time.

4. A device as claimed in claim 1, wherein the transducer elements are arranged in an staggered array, with each transducer element being circumferentially offset with respect to at least one other transducer element in the array so that each transducer element can be circumferentially offset with respect to at least one other transducer element within the array.

5. A device as claimed in claim 1, wherein the array is circular in cross section.

6. A device as claimed in claim 1, wherein the device has a longitudinal axis, and wherein the transducer elements are arranged in an axially stacked array, with a first row of transducer elements arranged side by side, arranged to transmit acoustic signals radially outward from the device, and a second row of transducer elements axially spaced from the first row of transducer elements, wherein each transducer element in the second row is circumferentially offset with respect to at least one transducer element in the first row.

7. A device as claimed in claim 1, wherein the device has a longitudinal axis, and wherein the transducer elements are arranged in an radially stacked array, with a first radial layer of transducer elements arranged side by side, arranged to transmit acoustic signals radially outward from the device, and a second radial layer of transducer elements radially spaced from the first radial layer of transducer elements and within the same axial plane of the device as the first radial layer, wherein each transducer element in the second layer is circumferentially offset with respect to at least one transducer element in the first layer.

8. (canceled)

9. A device as claimed in claim 1, wherein having a first circumferential array of transducer elements configured to transmit and receive at a first frequency, and a second circumferential array of transducer elements that transmit and receive at a second frequency that is different from the first frequency.

10. A device as claimed in claim 9, wherein the first circumferential array and the second circumferential array are each located in different radial planes of the device.

11. A method for inspecting a fluid bearing pipe, the method comprising the steps of:
providing an inspection device having a body and an acoustic transducer with a plurality of transducer elements mounted on the body and arranged in a circumferential array around substantially the whole circumference of the transducer, and passing the body of the inspection device into the pipe so that the acoustic transducers are radially spaced from the wall of the pipe;
generating acoustic signals from the acoustic transducer radially outwards from the body towards the pipe so that acoustic signals from the transducer are returned from the pipe and are received at the transducer;
transmitting and receiving acoustic signals around substantially the whole circumference of the device;
calculating the distance between the transducers and the pipe based on the returned signals received at the array; and
transmitting signals from the acoustic transducer at more than one acoustic frequency.

12. A method as claimed in claim 11 wherein acoustic signals are transmitted and received around substantially the whole circumference of the array at substantially the same time.

13. An inspection device comprising an acoustic transducer, the acoustic transducer comprising:
a plurality of transducer elements arranged in a first array, the first array having a transmitter mechanism that transmits acoustic signals from the device toward an inspected object to generate returned signals from the inspected object in response to the transmitted signals, and a receiver mechanism for receiving acoustic signals returned from the inspected object;
wherein the first array transmits and receives acoustic signals at a first frequency;
a plurality of transducer elements arranged in a second array, the second array having a transmitter mechanism that transmits acoustic signals from the device toward an inspected object to generate returned signals from the inspected object in response to the transmitted signals, and a receiver mechanism for receiving acoustic signals returned from the inspected object; and
wherein the second array transmits and receives acoustic signals at a second frequency.

14. A method of inspecting an object, the method comprising the steps of:
generating acoustic signals from a transducer within range of the object, so that acoustic signals from the transducer are returned from the object and are received at the transducer, and wherein the transducer comprises a first array of transducer elements and a second array of transducer elements;
transmitting acoustic signals at a first frequency from the first array of transducers; and
transmitting acoustic signals at a second frequency from the second array of transducers.

15. A method as claimed in claim 14, wherein:
the signals from the first and second arrays generate respective first and second return signals from first and second portions of the inspected object; and
the first and second portions of the inspected object are located at different distances from the transducer.

16. A device as claimed in claim 1 comprising a memory for storing data collected by the acoustic transducer.

17. A device as claimed in claim 1 comprising a speed of sound measurement device for measuring the speed of sound in the medium surrounding the inspection device.

18. A method as claimed in claim 11, wherein the acoustic signals are transmitted through a fluid medium, and wherein the speed of sound in the fluid medium is measured by a speed of sound measuring device on the body of the inspection device.

19. A method as claimed in claim 11, wherein the data collected by the inspection device is stored on a memory device on the body.
